(19) United States
(12) Patent Application Publication
(10) Pub. No.: US 2018/0114003 A1
(43) Pub. Date: Apr. 26, 2018

(54) Authentication Device, Authentication Method, and Electronic Device That Reduce Password Peeking by Third Person

(71) Applicant: Kyocera Document Solutions Inc., Osaka (JP)

(72) Inventor: Hiroyuki Uenishi, Osaka (JP)

(21) Appl. No.: 15/794,233

(22) Filed: Oct. 26, 2017

(30) Foreign Application Priority Data
Oct. 26, 2016 (JP) 2016-210090

(51) Int. Cl. G06F 21/31; G06F 3/0488

(52) U.S. Cl. CPC G06F 21/31; G06F 3/04883

(57) ABSTRACT

An authentication device includes a storage unit, an operation display, and an authentication unit. The storage unit stores a registered password for authentication associated with a user name. The operation display generates a password for temporary authentication in response to entering the user name. The password for temporary authentication is generated by removing a part of the registered password for authentication. The operation display displays removal specifying information for identifying the removal and accepts entering a password candidate. The authentication unit performs authentication when the entered password candidate matches the password for temporary authentication and does not perform authentication when the password does not match the password for temporary authentication.

### INCORPORATION BY REFERENCE

This application is based upon, and claims the benefit of priority from, corresponding Japanese Patent Application No. 2016-210090 filed in the Japan Patent Office on Oct. 26, 2016, the entire contents of which are incorporated herein by reference.

### BACKGROUND

Unless otherwise indicated herein, the description in this section is not prior art to the claims in this application and is not admitted to be prior art by inclusion in this section.

Portable terminals are typical examples of electronic devices that store data, such as personal information, that only the regular user should be permitted to access, by requiring password-based authentication. In authentication with a password, it is necessary for the user to enter a user name and a password to perform the authentication process. Such situations risk that a third party could peek at the entered password, and thus this is one of the problems for which a fixed password, which has been registered, is used.

Considering problems of this kind, there is proposed a technique that randomly inserts dummy numerals “162” into a registered password number “0704” registered in an authentication server to generate a dummy input pattern (for example, “1**6*2*”) of the password where the registered password number in “1076024” are replaced with asterisks “*” as hiding symbols so as to prevent the third person from peeking the password of the user. Meanwhile, there is also proposed a technique where around 10 pieces of passwords, which a target person remembers, are registered in a database, about three keywords are randomly selected from their keyword group, and then receives a password.

### SUMMARY

An authentication device according to one aspect of the disclosure includes a storage unit, an operation display, and an authentication unit. The storage unit stores a registered password for authentication associated with a user name. The operation display generates a password for temporary authentication in response to entering the user name. The password for temporary authentication is generated by removing a part of the registered password for authentication. The operation display displays removal specifying information for identifying the removal and accepts entering a password candidate. The authentication unit performs authentication when the entered password candidate matches the password for temporary authentication and does not perform authentication when the password does not match the password for temporary authentication.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram illustrating a functional configuration of an image forming apparatus according to one embodiment of the disclosure.

FIG. 2 illustrates contents of an authentication process according to the one embodiment.

FIGS. 3A and 3B illustrate explanatory diagrams illustrating login screens according to the one embodiment.

FIG. 4 illustrates contents of a password entering process according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes a configuration for implementing the disclosure (hereinafter referred to as “embodiment”) with reference to the drawings.

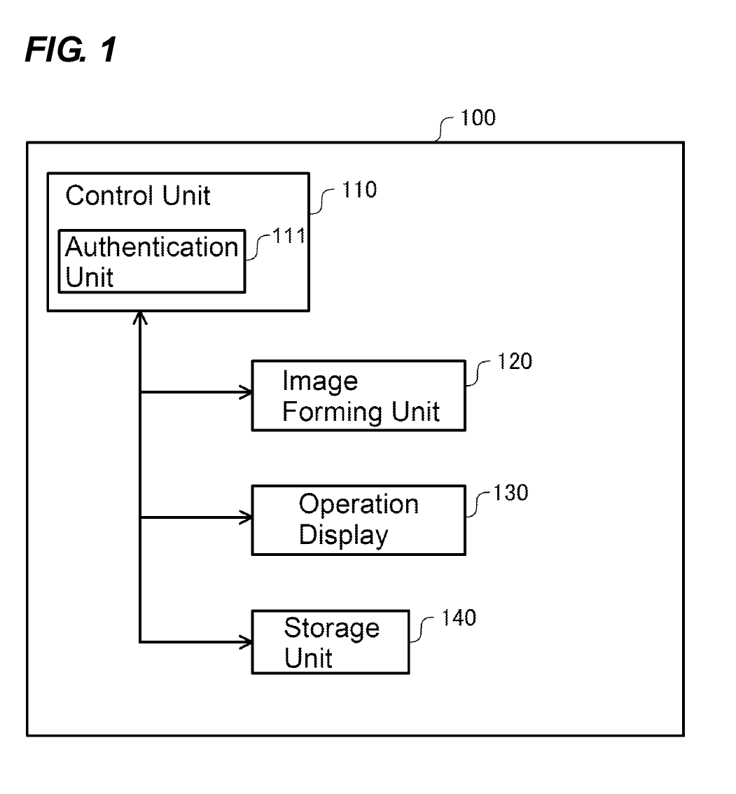

FIG. 1 illustrates a block diagram illustrating a functional configuration of an image forming apparatus 100 according to one embodiment of the disclosure. The image forming apparatus 100 includes a control unit 110, an image forming unit 120, an operation display 130, and a storage unit 140. The image forming unit 120 reads an image from an original document to generate image data, so as to perform printing on a print medium based on the processed image data. The operation display 130 functions as a touch panel to accept an input of a password by a user. The control unit 110 includes an authentication unit 111 that performs a user authentication using a password. The control unit 110 releases a use restriction of the image forming apparatus 100 in response to the user authentication. The use restriction is, for example, a restriction on a function that is permitted to only the authenticated user.

The control unit 110 includes a main storage unit, such as a RAM and a ROM, and a control unit, such as a micro-processing unit (MPU) and a central processing unit (CPU). The control unit 110 has a controller function related to an interface, such as various I/Os, a universal serial bus (USB), a bus, and another hardware, and controls the whole image forming apparatus 100.

The storage unit 140 is a storage device constituted of a hard disk drive, a flash memory, or a similar medium, which are non-transitory recording media, and stores control programs and data for processes performed by the control unit 110. The storage unit 140 further stores a registered password for authentication associated with a user name.

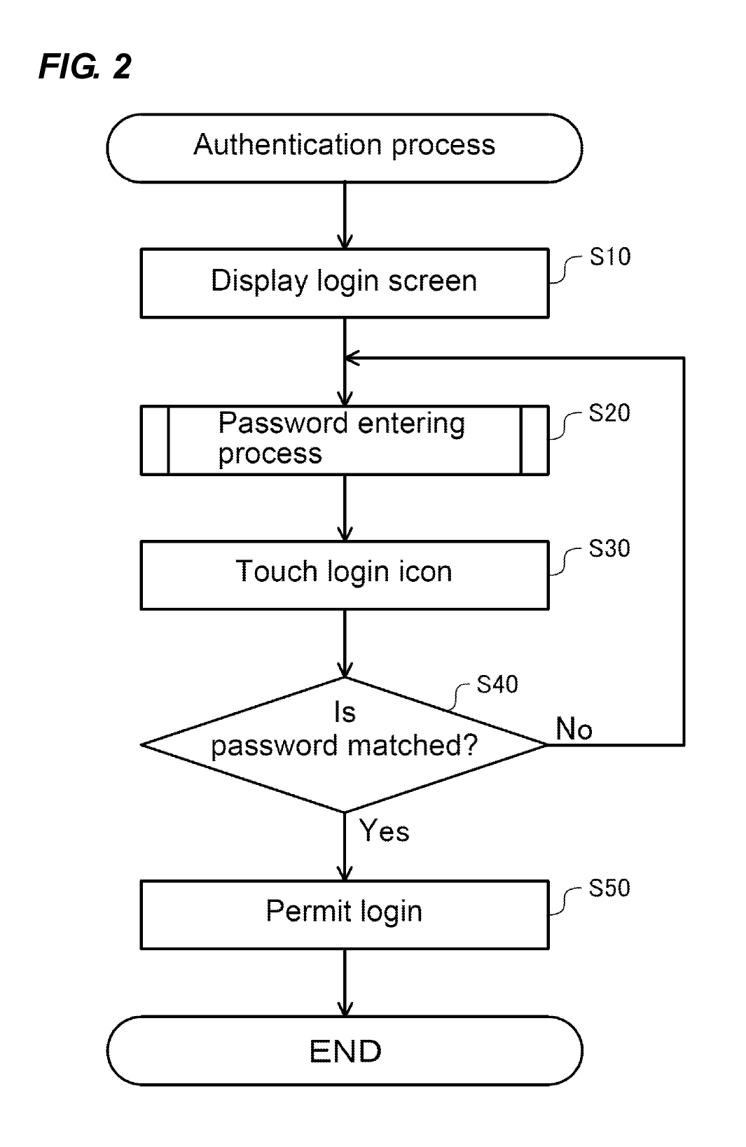

FIG. 2 illustrates contents of an authentication process according to the one embodiment. At Step S10, the user touches, for example, the operation display 130 of the image forming apparatus 100, which is in a non-login state. The control unit 110 displays a login screen 131 in response to the touch on the operation display 130.

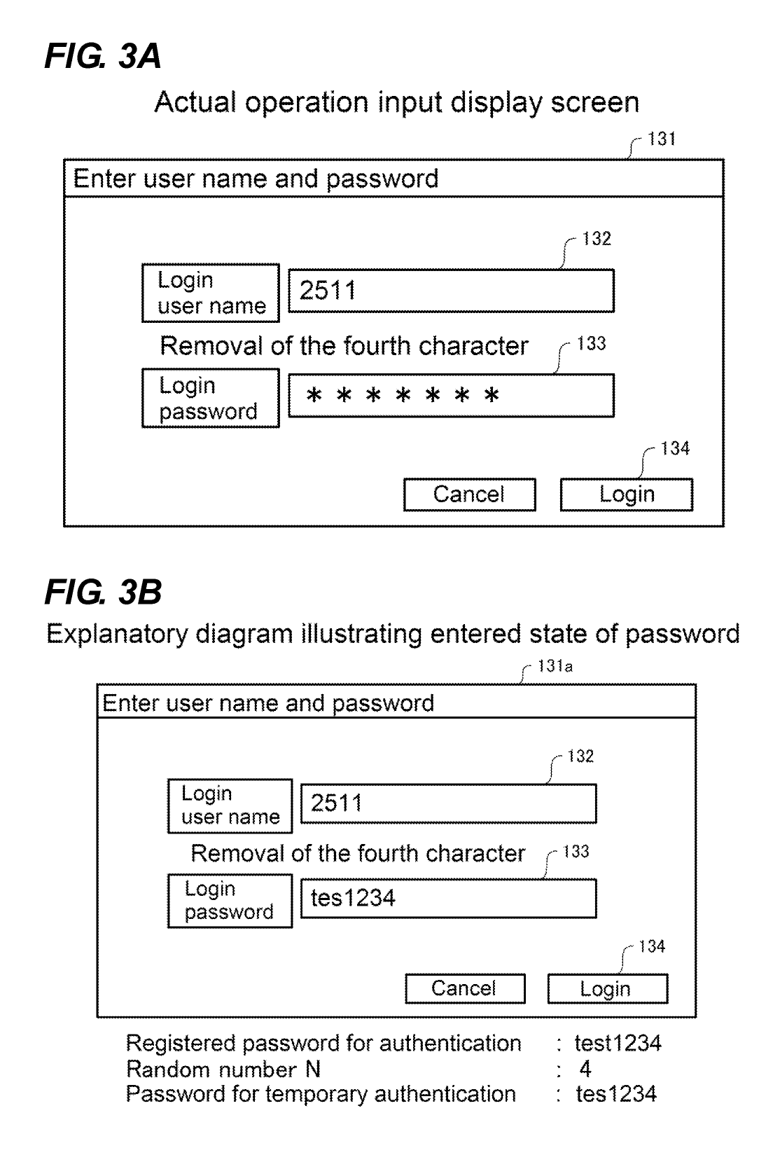

FIGS. 3A and 3B illustrate explanatory diagrams illustrating the login screens 131 and 131a according to the one embodiment. The login screen 131 includes a user name field 132 for entering a login user name, a password field 133 for entering a password, which is constituted as a character string, and a login icon 134. In the user name field 132, an employee number “2511” is entered as the user name.

FIG. 3A illustrates an operation input display screen, which is actually displayed, and FIG. 3B illustrates the login screen 131a as an explanatory diagram illustrating an entered state of a password. The login screen 131 according to the embodiment equally displays an entered state of respective characters of an entered password with predetermined symbols (symbols of “*”) such that the entered characters are not identified by a third person. This ensures the reduction of the case where the third person peeks it to know the password.

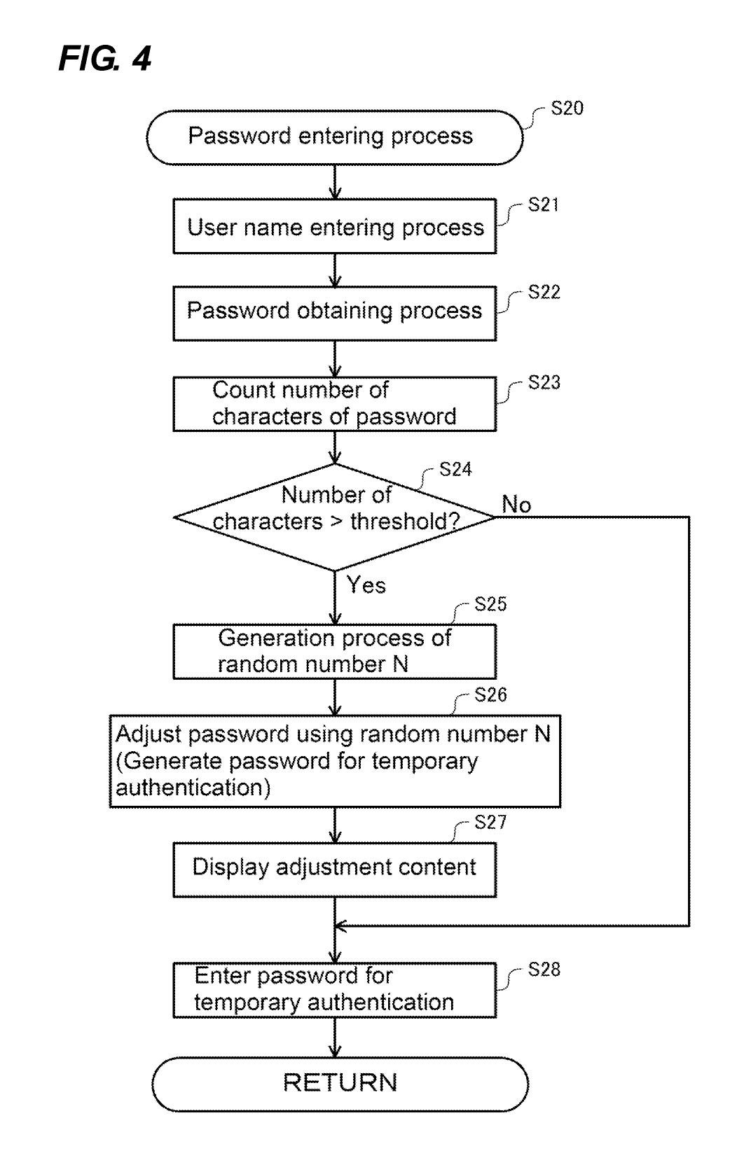

FIG. 4 illustrates contents of a password entering process according to the one embodiment. At Step S20, the user performs the password entering process. At Step S21, the user performs a user name entering process. In the user name entering process, the user enters the own employee number “2511” into the user name field 132. As the input method, an on-screen keyboard (not illustrated) displayed on the operation display 130, which functions as a touch panel, may be used, and a keyboard (not illustrated), which the image forming apparatus 100 additionally includes, may be used.

At Step S22, the authentication unit 111 performs a password obtaining process. The authentication unit 111 reads the registered password for authentication, which is preliminarily associated for each user to be registered in the storage unit 140, from the storage unit 140 so as to obtain it. In this example, assume that the registered password for authentication is “test1234.” At Step S23, the authentication unit 111 counts the number of characters of the registered password for authentication. In this example, it is counted as eight characters of “test1234.”

At Step S24, the authentication unit 111 compares the number of characters of the registered password for authentication with a threshold (which is set to two characters in this example). This is because when the number of characters of the registered password for authentication is excessively small, its use environment is assumed where the third person is not assumed to steal the password.

When the number of characters of the registered password for authentication (eight in this example) is larger than the threshold (two in this example), the authentication unit 111 advances the process to Step S25. On the other hand, when the number of characters of the registered password for authentication is equal to or less than the threshold, the authentication unit 111 advances the process to Step S28 by skipping the processes of Steps S25 to S27.

At Step S25, the authentication unit 111 generates a random number N that is in a range of the number of characters of the registered password for authentication (a range of 1 to 8). In this example, assume that the authentication unit 111 generates “4” as the random number N.

At Step S26, the authentication unit 111 adjusts the password using the random number N to generate a password for temporary authentication. This enables the authentication unit 111 to generate “tes1234” as the password for temporary authentication. The password for temporary authentication is generated by removing the fourth character as the random number N from “test1234” as the registered password for authentication.

At Step S27, the authentication unit 111 displays an adjustment content of the password. Specifically, the authentication unit 111 displays a text of “removal of the fourth character,” which indicates that the fourth character has been removed, on the operation display 130. This text is also referred to as “removal specifying information.”

At Step S28, the user estimates “tes1234” as the password for temporary authentication from “test1234” as the registered password for authentication in accordance with the display of “removal of the fourth character.” The user enters the estimated “tes1234” into the password field 133 of the login screen 131.

At Step S30 (see FIG. 2), the user touches the login icon 134 in response to a completion of entering the password. At Step S40, the authentication unit 111 determines whether the entered password (also referred to as a password candidate) matches the password for temporary authentication or not. When both the sides match, the process proceeds to Step S50, and the login of the user whose employee number is “2511” is permitted. Meanwhile, when both the sides do not match, the authentication is rejected (that is, the authentication is not performed), and the process returns to Step S20.

At Step S50, after the authentication based on the match between the entered password and the password for temporary authentication, the authentication unit 111 permits the login to perform a login process.

Thus, in the image forming apparatus 100 according to the embodiment, the authentication can be performed by entering only a part of the password. In view of this, the third person cannot know the whole password even when peeking an operation input of the user. In the embodiment, this ensures the reduction of obtaining the whole password by the third person who peeks an operation input of the user while the user enters the password on the keyboard (not illustrated).

In addition to the above-described respective embodiments, the following modifications implement the disclosure.

### Modification 1

In the above-described embodiment, the random number N is generated in the range of the number of characters of the registered password for authentication, and the character located at the position determined based on the random number N is removed. That is, for example, when “4” is generated as the random number N, “tes1234,” where the fourth character is removed from “test1234,” is generated as the password for temporary authentication.

However, a method of removing a character when the password for temporary authentication is generated from the registered password for authentication is not limited to such method. For example, the character located at the position determined based on the random number N, and a character identical to this character may be removed to generate “es1234.” This means that the third person cannot know even the removed position of character.

### Modification 2

While in the above-described embodiment the random number N is generated in the range of the number of characters of the registered password for authentication, the selection method is not limited insofar as a character is randomly selected from the characters of the registered password for authentication using some sort of method.

### Modification 3

While in the above-described embodiment the removal specifying information is a text indicative of a position of a character to be removed, for example, may be a character “t.” This ensures the reduced load of the user who enters a password. On the other hand, the third person cannot obtain the password because the position of the removed character is unknown.

### Modification 4

While in the above-described embodiment the disclosure is embodied as the image forming apparatus, the disclosure is applicable to an authentication device available in, for example, a portable terminal, a tablet, and other electronic devices that may store personal information and similar information. In this case, for example, the portable terminal and the tablet are restricted to use a predetermined function, and the portable terminal and the tablet include a functional unit that releases the use restriction of the predetermined function in response to authentication by this authentication device.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An authentication device comprising:
a storage unit that stores a registered password for authentication associated with a user name;
an operation display that generates a password for temporary authentication in response to entering the user name, the password for temporary authentication being generated by removing a part of the registered password for authentication, the operation display displaying removal specifying information for identifying the removal, and accepting entering a password candidate; and
an authentication unit that performs authentication when the entered password candidate matches the password for temporary authentication and does not perform authentication when the password does not match the password for temporary authentication.

2. The authentication device according to claim 1, wherein the operation display removes a character located at a position randomly selected as a part of the registered password for authentication and then displays the position of the removed character.

3. The authentication device according to claim 1, wherein the operation display removes a character randomly selected as a part of the registered password for authentication and displays any one of the positions of the removed character.

4. The authentication device according to claim 1, wherein the operation display removes a part of the registered password for authentication when a count of characters of the registered password for authentication is larger than a preliminarily set count of characters.

5. An electronic device comprising:
the authentication device according to claim 1; and
a functional unit that restricts a predetermined function and releases a use restriction of the predetermined function in response to the authentication by the authentication device.

6. An authentication method comprising:
storing a registered password for authentication associated with a user name;
generating a password for temporary authentication that is generated by removing a part of the registered password for authentication in response to entering the user name, displaying removal specifying information for identifying the removal, and accepting entering a password candidate; and
authenticating when the entered password candidate matches the password for temporary authentication and not authenticating when the password does not match the password for temporary authentication.

7. A non-transitory computer-readable recording medium storing an authentication program that controls an authentication device, the authentication program causing the authentication device to function as:
a storage unit storing a registered password for authentication associated with a user name;
an operation display that generates a password for temporary authentication in response to entering the user name, the password for temporary authentication being generated by removing a part of the registered password for authentication, the operation display displaying removal specifying information for identifying the removal and accepting entering a password candidate; and
an authentication unit that performs authentication when the entered password candidate matches the password for temporary authentication and does not perform authentication when the password does not match the password for temporary authentication.
